(19) United States
(12) Patent Application Publication
(10) Pub. No.: US 2026/0067546 A1
(43) Pub. Date: Mar. 5, 2026

(54) MULTI-CHANNEL CONTENT REMIX

(71) Applicant: HUBSPOT, INC., Cambridge, MA (US)

(72) Inventors: Stephy Mathew, Campbell, CA (US); Kaitlin Nye Magee, Williamstown, MA (US); Brian Dennis Doherty, Tyngsboro, MA (US); Cole Charles Markham, College Station, TX (US); Kathryn LaVonne Tade, Wellesley, MA (US); Nicholas L. Holland, Nolensville, TN (US); Matthew Blake Reichenbach, Richmond, KY (US); Lisa Marie Covino, Melrose, MA (US)

(21) Appl. No.: 18/820,729

(22) Filed: Aug. 30, 2024

(51) Int. Cl. H04N 21/854

(52) U.S. Cl. CPC H04N 21/854

(57) ABSTRACT

Systems and methods are provided for multichannel content remix. A flow is defined for generating new content based upon source content. The flow is defined with nodes arranged according to a graph structure such that downstream nodes utilize output from upstream nodes as input. An execution engine processes each node of the flow by identifying an executor associated with a node type of a node. If the node is a downstream node, then an output of an upstream node is used to as input for the downstream node.

The node is executed to generate a prompt that is input into a machine learning model to create a node result for the node. Once the execution engine has processed the nodes of the graph structure, the node results are used to generate the new content that is provided through a content provider channel.

### BACKGROUND

A content service provider generates content that is provided to user devices through content provider channels. The content may include emails, websites, text messages, social network posts, videos, documents, presentations, blogs, audio summaries, information derived from objects within a customer relationship database, and/or a variety of other electronic content. The content may be provided through various content provider channels such as through an email service, a social network, a website, a blogging site, etc. Unfortunately, a significant amount of computing resources, time, and manual effort is consumed to separately create different types of content for each type of content provider channel. For example, computing resources are consumed to separately create a video to display through a social media post, an image and email to send to an email recipient, and multimedia content to display through a website.

### DESCRIPTION OF THE DRAWINGS

Embodiments of the present technology will be described and explained through the use of the accompanying drawings in which:

FIG. 1 is a block diagram illustrating an embodiment of a system for multi-channel content remix, in accordance with an embodiment of the present technology.

FIG. 2 is a flow chart illustrating an embodiment of a method for multi-channel content remix, in accordance with an embodiment of the present technology.

FIG. 3 is a flow chart illustrating an embodiment of a method for multi-channel content remix, in accordance with an embodiment of the present technology.

FIG. 4A is a block diagram illustrating an embodiment of a user interface for multi-channel content remix, in accordance with an embodiment of the present technology.

FIG. 4B is a block diagram illustrating an embodiment of a user interface for multi-channel content remix, in accordance with an embodiment of the present technology.

FIG. 4C is a block diagram illustrating an embodiment of a user interface for multi-channel content remix, in accordance with an embodiment of the present technology.

FIG. 4D is a block diagram illustrating an embodiment of a user interface for multi-channel content remix, in accordance with an embodiment of the present technology.

FIG. 4E is a block diagram illustrating an embodiment of a user interface for multi-channel content remix, in accordance with an embodiment of the present technology.

FIG. 4F is a block diagram illustrating an embodiment of a user interface for multi-channel content remix, in accordance with an embodiment of the present technology.

FIG. 4G is a block diagram illustrating an embodiment of a user interface for multi-channel content remix, in accordance with an embodiment of the present technology.

FIG. 5 is an example of a computer readable medium in which an embodiment of the present technology may be implemented.

FIG. 6 illustrates an exemplary computing environment wherein one or more of the provisions set forth herein may be implemented.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

System and methods are provided for multi-channel content remix that creates new content derived from source content. The source content may include a specific type of content such as images and text within an email associated with an email content provider channel. Multi-channel content remix can create the new content from multiple pieces of source content and/or from non-content items (e.g., customer relationship management data, content graph data, a phone call recording, a transcript, a spreadsheet, an object within a customer relationship management database, etc.). The source content may be transformed using machine learning and artificial intelligence (ML/AI) into new content that may have a different content type than the source content. For example, a machine learning model, an artificial intelligence content generator, and/or other content generation services may be invoked to transform the images and text of the email into a video that can be shared through a social network post. Leveraging machine learning and artificial intelligence to create the new content tailored for various types of content provider channels (e.g., transforming the email into the video, a social network post, a blog, a presentation, a website, a knowledge base article, a podcast, a podcast page, etc.) significantly reduces the processing resources, time, and manual effort associated with creating each individual content item from scratch. Instead, existing source content is leveraged to create the new content, which consumes less resources, time, and effort.

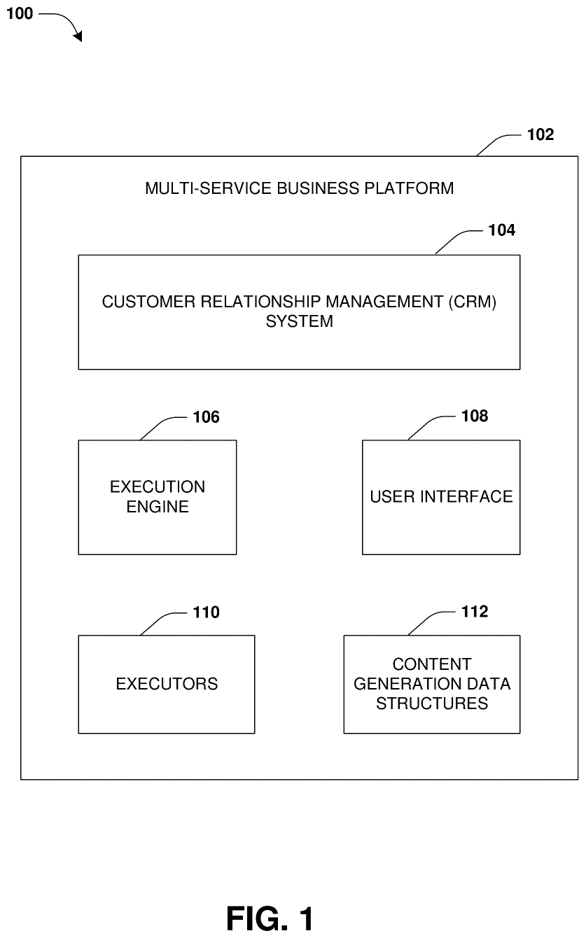

FIG. 1 is a block diagram illustrating an embodiment of a system 100 for multi-channel content remix. An execution engine 106 may be configured to execute flows for implementing the multi-channel content remix. The execution engine 106 may be incorporated into a multi-service business platform 102. The multi-service business platform 102 may host a customer relationship management (CRM) system 104 that stores customer relationship data within objects such as core objects and custom objects (e.g., a customer object specifying information about a customer, a product object specifying information about a product, a deal object specification a deal to sell the product to the customer, etc.).

The execution engine 106 may utilize executors 110 to transform source content into new content. In particular, the execution engine 106 may receive a flow defined by a user through a user interface or defined in code generated by a service. The execution engine 106 utilizes the flow for transforming the source content into the new content by reading the flow, looking up executors, and invoking the executors to perform the work defined by the flow. The flow may include nodes that are arranged in a graph structure. The nodes correspond to the new content to generate. Each node type encapsulates proprietary prompts and logic to generate high-quality content of a particular type. This allows users that have little knowledge of AI content generation to produce quality content (e.g., a blog, image, email, social media post, or presentation that adequately conveys information and/or may be aesthetically pleasing to humans). Users are able to configure each node using various attributes. The attributes allow customization of the generated content. Each node uses a parent node (an upstream node) in the graph structure as input. The top-level node(s) of the graph structure represent the source content. The top-level node(s) are responsible for loading the source content selected by the user (e.g., blog posts, documents, videos, audio files, website pages, etc.). The top-level node(s) may also include processing of the input for various purposes such as: feature extraction (e.g., identifying visual features of an image such as entities depicted by the image; identifying keywords and topics of text; etc.), sanitization, data cleanup, summarization, identification of key points, etc.

The execution engine 106 may utilize various content generation data structures 112 stored within data storage of the multi-service business platform 102. The data storage may include a first data structure used to store a flow definition that consists of input content selection, output content types, and various configuration attributes. The data storage may include a second data structure such as an execution history table that stores the results of each flow after being processed.

In some embodiments, a flow or a subset of a flow (e.g., certain nodes) may be executed multiple times to produce variations of the outputs (e.g., various blogs may be generated from a source email represented by one or more nodes to process). When a flow is executed, the nodes are duplicated into the execution history table to preserve the graph structure and attributes of the nodes, such as in case of subsequent changes. Each node in the execution history table stores: attributes, execution status (e.g., pending, running, completed, failed, etc.). The result of each node's execution is an interstitial state (a node result) that represents the content type.

The execution engine 106 processes a flow definition, and stores the results in the execution history table of the content generation data structures 112. In some embodiments, the content generation data structures 112 represent the storage of data and information used by the execution engine 106 for multi-channel content remix (e.g., a temporary storage of information and data used as part of multi-channel content remix, such as a database). In some embodiments, the content generation data structures 112 represent the storage of source content and/or new content (e.g., a content database of the multi-service business platform 102). For each node type, there is an executor that coordinates that calling of various application programming interfaces (APIs) and machine learning models such as large language models (LLMs) to generate the output content based on the inputs and attributes. The executor takes the input from an upstream node, extracts any relevant information, and adds that to a prompt used to call a machine learning model. The executor may also use context from previous upstream nodes in the graph structure for generating the prompt. There may be multiple machine learning model calls that are executed in parallel or in series to build the final result of the new content (e.g., different branches of the graph structure may be processed in parallel for more efficiently created the new content in a shorter amount of time). The executor is responsible for coordinating these calls. The output of the executor is the interstitial state for that content type associated with the current node being processed by the executor. The interstitial state is stored as a node result in the execution history.

To begin the execution, the top-level node(s) are placed into a queue, and are set to a waiting state. As each node in the queue is processed, the state is set to a running state. The execution engine 106 checks to see whether a node should be executed or cloned from a prior execution. If the node is to be cloned, then attributes and a node result from the prior execution of the node are copied for the current instance of the node. If the node does not exist in a prior execution (e.g., because the node was newly added or previously failed), then the node will be executed. If the node is not being cloned (or unable to be cloned), then the node will be executed.

For nodes being executed, the appropriate executor is located based on the node type. If there is no appropriate executor corresponding to the node type of the node to execute, then the node is marked as failed. After the executor processes the node successfully, the node result is stored and the node state is updated to success. If the executor fails to process the node, the node and any downstream nodes are marked as failed.

After execution of the node, if there are downstream nodes, then the downstream nodes are added to the queue for execution. If there are no downstream nodes, then the execution engine 106 checks as to whether all nodes for the flow have completed (e.g., are there other nodes to execute or nodes still executing, which may be located in other branches of the graph structure). If execution of all nodes are complete, then the flow is marked as completed. Otherwise, the flow will be checked again when the other nodes complete.

The execution engine 106 may utilize a user interface 108 through which a user may configure a flow, select/upload source content, specify new content to create, view/modify the result of nodes executing, view progress of executing nodes, view/modify the new content, etc. While flow execution is running, the user interface 108 displays the state of each node. The user interface 108 polls a backend system periodically for the status of all nodes (e.g., executing, failed, success, etc.). When a node is in the pending state, a status indicator of the user interface 108 shows a solid gray bar to indicate that the node has not been executed. Once a node enters the running state, a colored progress bar is displayed through the user interface 108. In some embodiments, a color of the colored progress bar corresponds to the node type (e.g., a first color for a first node type such as image, a second color for a second node type such a video, a third color for a third node type such as website, etc.). The duration of the progress bar is based on an estimated run time to execute the node. The estimated run time may be computed based on historical results (e.g., measured run times of prior executions of the node or similar nodes such as the time to transform a text document into a presentation), and may be varied depending on attribute and configuration of the node (e.g. if a blog post or website includes generated images, then a duration of the estimated run time may be increased). As the executors 110 complete execution of the nodes, the status indicator is modified to show a solid colored bar that represents the node type. In some embodiments, the user interface 108 displays the nodes, and a body of a node is rendered with a preview of the generated content (e.g., a preview of a blog post being generated through execution of a node).

A user is provided with the ability to preview the generated content by clicking on the node. In response to clicking the node through the user interface 108, the user is provided with functionality such as a button to persist the generated content (new content) to the multi-service business platform 102 such as to the CRM system 104. The user interface 108 providers the user with the ability to save the generated content (new content) into the multi-service business platform 102 for use by various services that relate to providing web pages, blogs, sending emails, facilitating social networking, etc.). Once saved to the multi-service business platform 102, the user is provided with the ability to further edit and/or publish the generated content (e.g., a generated blog post may be provided through a blogging service for the user to edit or publish). For each content type, there is a handler that converts the interstitial state output by each node (e.g., node results of each node), to the required format of the new content, and calls internal APIs to create and finalize the new content.

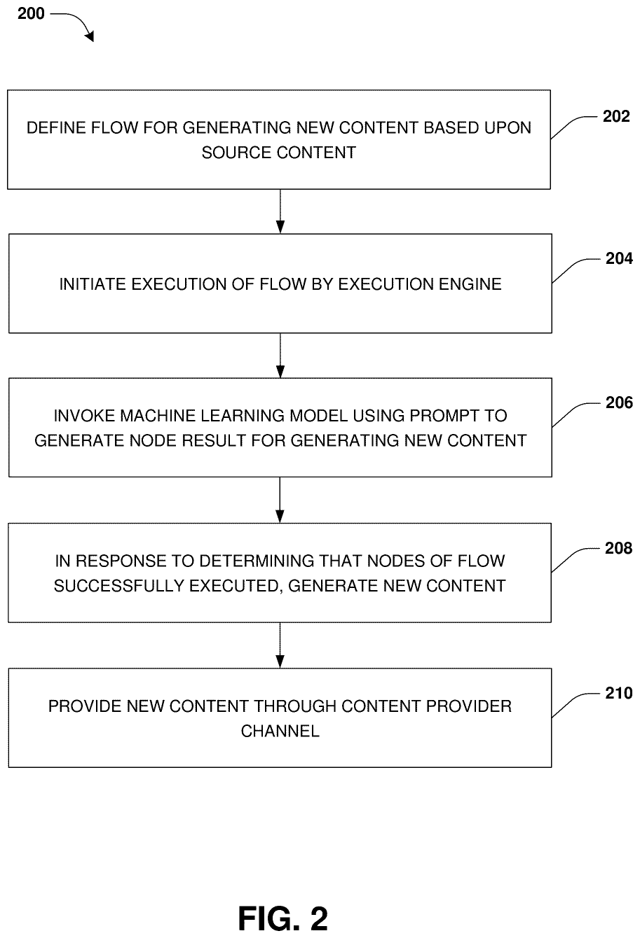

FIG. 2 is a flow chart illustrating an embodiment of a method 200 for multi-channel content remix. A request may be received to generate new content based upon source content. The source content and/or the new content may have the same or different content type (e.g., an image and video may be transformed into a website or email). The source content or the new content may correspond to a blog, an audio summary, a landing page, a website, a social network post, an email, a text message, an image, a video, a document, a presentation, a spreadsheet, an object stored within the CRM system 104, or any other type of content. In some embodiments, multi-channel content remix can create the new content from multiple pieces of source content and/or from non-content items (e.g., customer relationship management data, content graph data, a phone call recording, a transcript, a spreadsheet, an object within a customer relationship management database, a URL, online business documents, deep integration with external apps, etc.). The user may select and/or upload the source content, and may specify what type of new content to create, which may be input through the user interface 108.

During operation 202 of method 200, a flow is defined for generating the new content based upon the source content. The flow is defined based upon one or more output content types (e.g., a website to generate). It may be appreciated that any number of output content types may be defined for the flow. The flow is defined based upon configuration attributes such as a color scheme for the website, a theme for the website, a layout for the website (e.g., a shopping webpage with a checkout page), functionality to be provided by the website (e.g., shopping and purchase functionality where a website visitor can purchase items for sale through the website), etc. In particular, the nodes within the flow include the configuration attributes, and each node may contain its own set of attributes.

Each node (content type) has its own set of attributes. The set of attributes may include image attributes such as an image style to generate or image dimensions to generate. The set of attributes may include landing page attributes such as a template for use within a customer management services platform, an “objective” field to append to a large language model prompt (e.g., an objective such as to sending a marketing email, generate a promotional social network post, create an exciting car chase video, create a blog about running, etc.), and a checkbox for whether or not to generate images to use on the page. The set of attributes may include social attributes such as the type of social network targeted by the post (e.g., an image sharing social network, a business social network, and a general social network), an “objective” field, and a checkbox for whether or not to generate images to use on the social media post. The set of attributes may include audio attributes such as a computer voice type in which upstream text content should be read (e.g., a female voice, a male voice, an adult voice, etc.). The set of attributes may include video clip attributes such as an “objective” field, an aspect ratio of the video clips to generate, a number of video clips to generate, a network to target (e.g., a video sharing service, a video based social network, etc.). The attribute may be used to guide the executor on how to fetch content/data from the multi-service business platform. The attributes may be used to configure how/what data to fetch from the platform, how/where to storage the generated content, and/or settings that impact how the content is generated (e.g., influencing the construction of the LLM prompt, entering or skipping code paths such as for generating images for a

The flow is defined with the nodes arranged according to a graph structure. Each node may relate to a type of content to process or generate (e.g., an image generation node, a web page node, a blog generation node, a video generation node, etc.). Downstream nodes may utilize output from upstream nodes as input. In some embodiments, a top-level node is defined to represent the source content. The top-level node is configured with feature extraction functionality, content sanitization functionality, data cleanup functionality, summarization functionality, and/or key point identification functionality for processing the source content. In some embodiments, the top level node(s) (e.g., input nodes relating to the one or more source content items). The top level nodes(s) may consist of image, pdf, word docs, videos, audios, and/or other files (e.g., files in a file manager of the multi-service business platform 102). The top level node(s) may consist of existing content within the multi-service business platform 102, such as a hosted blog post, a landing page, an email, etc. The top level node(s) may consist of external content such as a webpage fetched using a URL. The top level node(s) may consist of text such as where a user manually copies and pastes the text into the user interface). The top level node(s) may be stripped of HTML from webpages in order to extract merely the text, used to perform a function calls to a platform tool to visually describe images, pdfs, videos for easier consumption during content remix, used to perform function calls, used to perform function calls to a platform tool to obtain spoken word transcripts of videos and audio files, etc.

Each node is defined based upon the new content to generate. Each node may be defined to include a proprietary prompt (e.g., a prompt that can be input into a machine learning model or ML/AI content generation service to create content based upon the prompt), logic to generate content of a particular content type (e.g., logic to generate a website, blog, social network post, presentation, etc.), and/or user specified attributes (e.g., a theme for the presentation, a number of pages for the presentation, etc.).

In some embodiments, a social node prompt that takes user configured attributes (e.g., objective and target social network) to create a prompt such as:
{% if parameters.objective %}

Additional instructions for the social media post:
===
{{parameters.objective}}
===
{%endif%}
source text:
===
{{parameters.sourceText|word_limit(2000)}}
===

The provided source text may contain research notes or other content that can be used to provide details in the social media post to create and post. The writing constraints may relate to: do not include this content directly or plagiarize from the content, do not make the social media post lengthy, keep the social media post concise and to the point, provide me with an engaging social media post {{parameters.forNetwork}} in {{language}} that is concise and

During operation 204 of method 200, execution of the flow by the execution engine 106 is initiated. In some embodiments, the nodes of the flow are queued into a queue in an order corresponding to the graph structure (e.g., a top-level node may be inserted into a top position of the queue, and leaf nodes may be inserted into bottom positions of the queue). States may be assigned to the nodes, such as a waiting state where the node is waiting to be executed, a running state where an executor is running/executing a node, a success state for a node successfully executed, a failed state for a node that failed to execute, etc. The nodes within the queue may be processed from a top-level node down through branches of nodes to leaf nodes. As part of executing the flow, the nodes are duplicated into an execution history table as duplicated nodes. The duplicated nodes preserve the graph structure of the nodes. The duplicated nodes store attributes of the nodes, execution status of the nodes, and/or results of the nodes being executed. In some embodiments, the specific node results are not treated/marked/stored as actual clones in storage, but a reference to a previous node results during execution is maintained or used. In some embodiments where a flow and/or nodes are executed a plurality of times such as to generate variations of the new content, a determination is made as to whether a node is to be executed or is to be cloned from a prior execution. In response to determining that the node is not to be cloned or is unable to be cloned, the node is executed. In response to determining that the node is to be cloned from a prior execution, attributes and execution results from the prior execution are copied as a cloned node designated as already executed based upon the copied attributes and copied execution results.

As part of executing a node of the flow, then execution engine 106 selects an executor associated with a node type assigned to the node (e.g., a blog executor for generating a blog). In some embodiments, an executor is code/methods/functions that take node specific attributes as input, and are configured to identify the results of a parent node(s) in order to generate specific content. The business logic of each node may be different. The execution engine evaluates a specific node in the flow during processing, and can look up in a map the matching executor code to invoke to process that node. If an executor associated with the node type is not identified, then the node is assigned a failed status. If a node is assigned a failed status (e.g., an executor cannot be identified or an executor fails to successfully execute the node), then all downstream nodes are assigned a failed status. As part of executing the node, the node is evaluated to determine whether the node is a downstream node that is downstream from an upstream node. If the node is the downstream node, then an output of the upstream node is extracted as an input for the downstream node for generating a prompt. The prompt is generated based upon the output content type of the node and the configuration attributes of the node. In this way, a custom tailored prompt is generated for executing the node. In some embodiments, the prompt is constructed based upon a proprietary prompt of the node, logic specified by the node to generate content of a particular content type, and/or user specified attributes of the node. In some embodiments, various user defined attributes (e.g., a word count of a blog, a topic for the blog, a target blogging site to post the blog. etc.) are injected into the prompt.

During operation 206 of method 200, a machine learning model (e.g., a machine learning model of an AI content generator, a large language model, etc.) is invoked using the prompt to generate a node result for generating the new content. For example, the prompt may include logic and instructions to create a blog based upon an image output by the upstream node. In another example, a social media post may be created from output related to a blog, a blog may be created from output related to an email, a PDF may be created from output related to the blog, a video may be created from output related to video clips, audio may be created from output related to a landing page, etc. In general, mode nodes may be connected to any other node (e.g., 15 different nodes may be combined in almost any permutation, and new nodes and node types may be defined).

The prompt is input into the machine learning model for generating the blog as the node result. The executor may coordinate multiple calls to APIs and/or models (e.g., large language models) in parallel or in series to generate an interstitial state of the output content, which is stored into the execution history table as the node result. A backend system hosting the execution engine 106 may be polled for status information regarding the nodes such as to determine whether all nodes have successfully executed. This status information may be populated within the user interface 108. In some embodiments, if a leaf node of a first branch is successfully executed, then the graph structure is evaluated to determine whether nodes of other branches have completed execution. In response to all nodes successfully being executed, the flow is marked as complete. In some embodiments, the interstitial state relates to raw text and/or an image generated for a social node. For a blog, the interstitial state may relate to a body, title, and meta-description for a blog post. For an image, the interstitial state may be a URL where an image is hosted. For landing pages and emails, the interstitial state may be a JSON blob that represents how content should be dispersed throughout underlying templates. The interstitial state is a content remix construct, and is used for providing a preview of content. If the user invokes a function such as “save and edit in app” functionality, then a persist function is called to convert the interstitial state (e.g., light weight data) into actual data that is stored within the platform. For example, JSON content for emails and landing pages (e.g., JSON being the light weight data of the interstitial state) will be converted into a much larger and more complex data structure in the platform that represents a real email or landing page (e.g., a structure that can be further converted into an actual published HTML page). Social post, blog, and/or other text can be converted into a larger and more complex data structure in the platform. In some embodiments the interstitial state is generated until a user saves/converts the interstitial state into the new content such as in response to the user clicking a save button.

During operation 208 of method 200, in response to determining that the nodes of the flow successfully executed, the new content is generated utilizing the node results created from execution of the flow by the execution engine 106. In this way, the source content is transformed from a source content type to the new content having an output content type that may be the same or different than the source content type. During operation 210 of method 200, the new content may be provided through a content provider channel for access by a computing device. For example, a blog may be published through a blog content provider channel, an email may be sent through an email content provider channel, a website may be published through a website content provider channel, etc. In some embodiments, the flow is executed a plurality of times to generate variations of the new content (e.g., variations of a blog that may have different text, images, etc.). The variations may be provided to a user through the user interface for selection. The user may select and/or modify a blog to publish through the content provider channel. In some embodiments, the nodes or representations of the nodes are displayed through the user interface 108. If a node has a running state, then a colored progress bar is displayed through the user interface 108. The colored progress bar is configured with a color corresponding to a node type of the content (e.g., a first color for an image, a second color for a presentation, a third color for a video, a fourth color for a social network post, etc.). The colored progress bar has a duration estimated based upon a runtime of the node. The runtime of the node may be computed based upon historic node execution results of similar nodes having a similar node type and/or based upon a node attribute configuration of the node (e.g., an image being enabled or disabled for the generation of a landing page or blog). In some embodiments, the colored progress bar is colored based upon a state of the node such as whether the node is pending to run, running, has successfully been executed, or has failed to execute. In some embodiments, a preview of content being generated by execution of the node is displayed through the node or a representation of the node through the user interface 108. In this way, a user may track progress of the method 200.

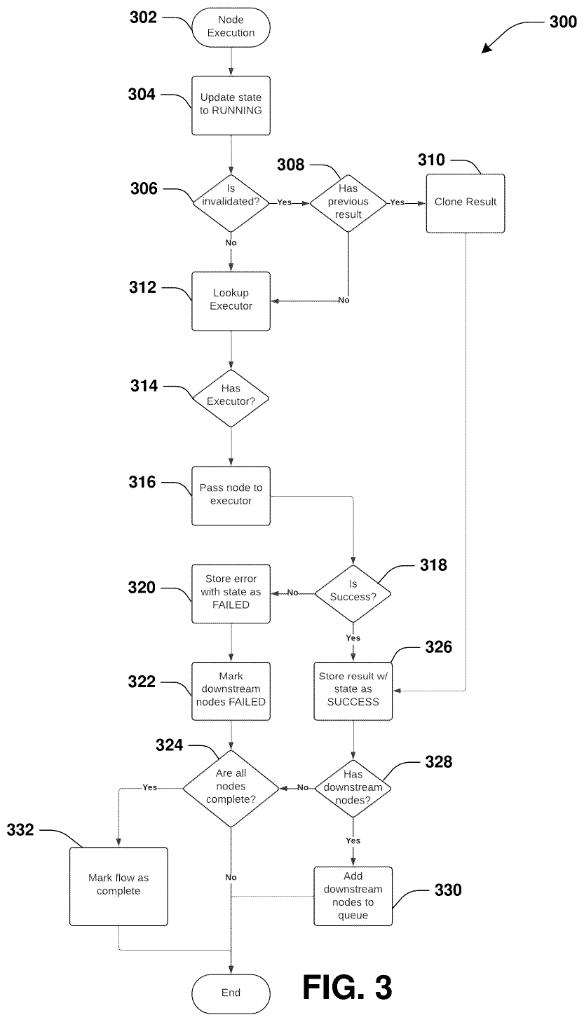

FIG. 3 is a flow chart illustrating an embodiment of a method 300 for multi-channel content remix. During operation 302 of method 300, node execution is initiated.

During operation 304 of method 300, a state of a node is updated to a running state based upon an executor being selected to execute/run the node. During operation 306 of method 300, a determination is made as to whether the node is invalidated for execution. If the node is invalidated for execution, then a determination is made as to whether there is a previous execution result from a prior execution of the node, during operation 308 of method 300. During operation 310 of method 300, the previous execution result is cloned and stored as an execution result for the node that is marked as successfully executed, during operation 326 of method 300. If the node is valid for execution, then an executor capable of executing the node is identified, during operation 312 of method 300. During operation 314 of method 300, a determination is made that there is a valid executor for the node. During operation 316 of method 300, the node is input into the executor for execution. A determination is made as to whether execution is successful, during operation 318 of method 300. If the operation is successful, then an execution result is stored for the node that is marked as successfully executed, during operation 326 of method 300. During operation 328 of method 300, a determination is made as to whether the node has any downstream nodes. If there are downstream nodes, then the downstream nodes are added to the queue for execution, during operation 330 of method. If execution of the node is not successful, then an error is stored and a state for the node is marked as failed, during operation 320 of method 300. During operation 322 of method 300, downstream nodes of the failed node are marked as failed. During operation 324 of method 300, a determination is made as to whether all nodes have been processed. If all nodes have been processed, then the flow is marked as complete, during operation 332 of method 300.

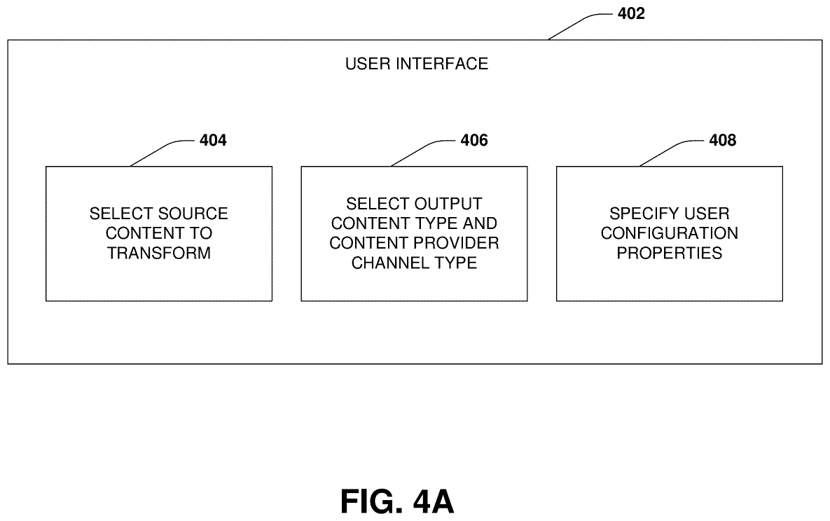

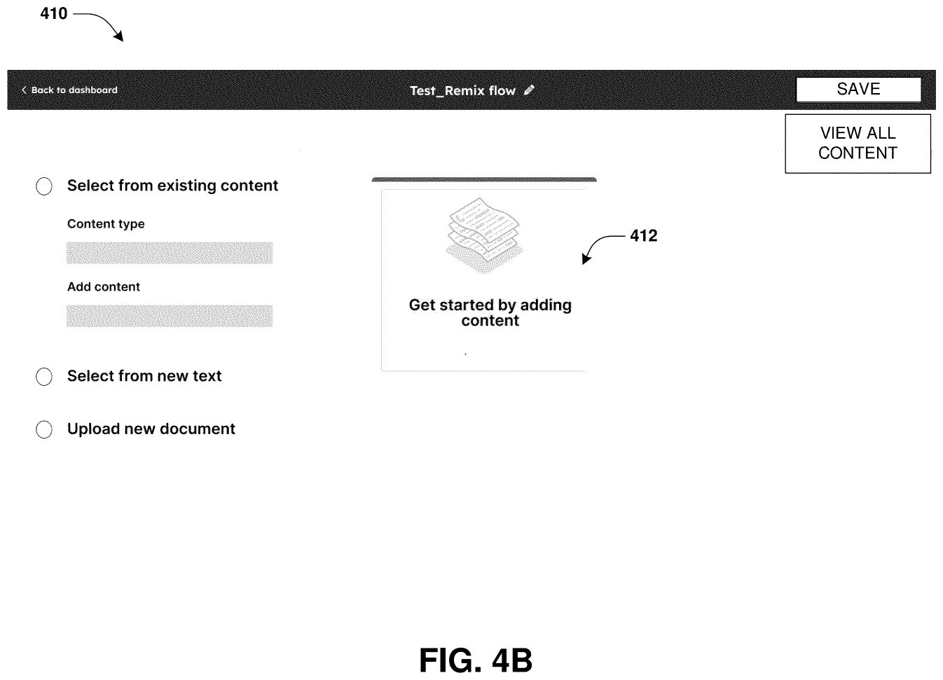

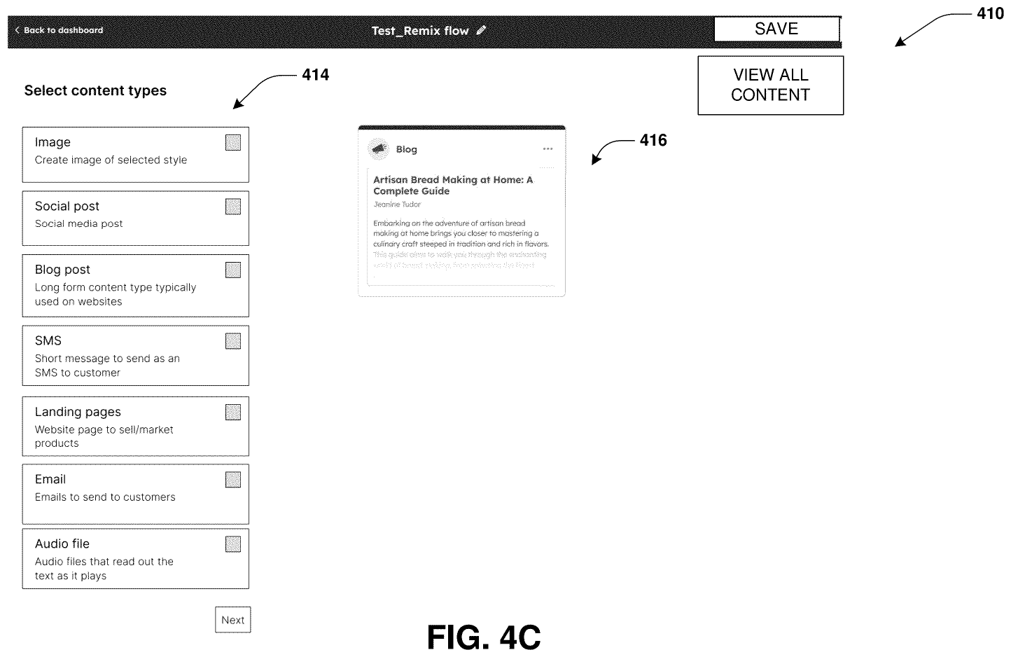

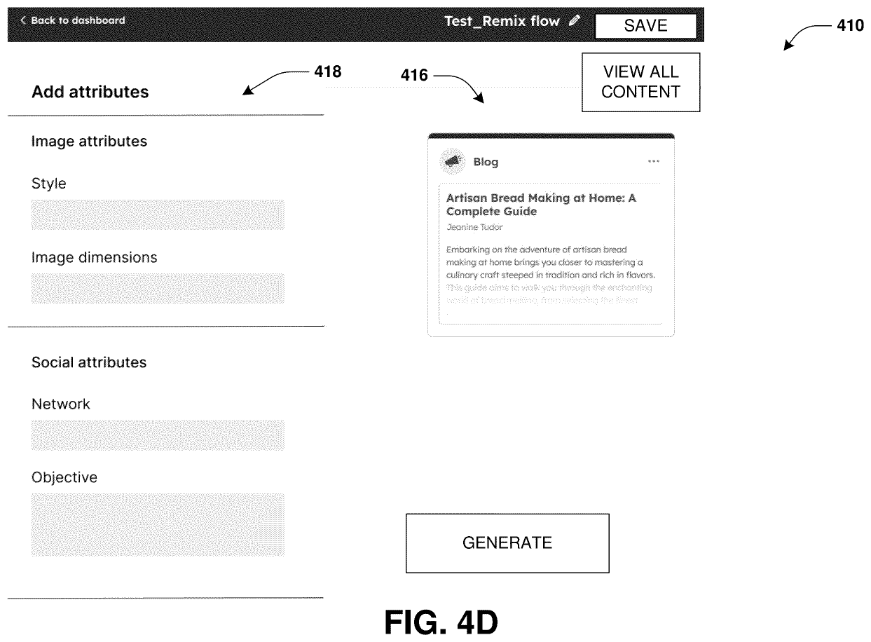

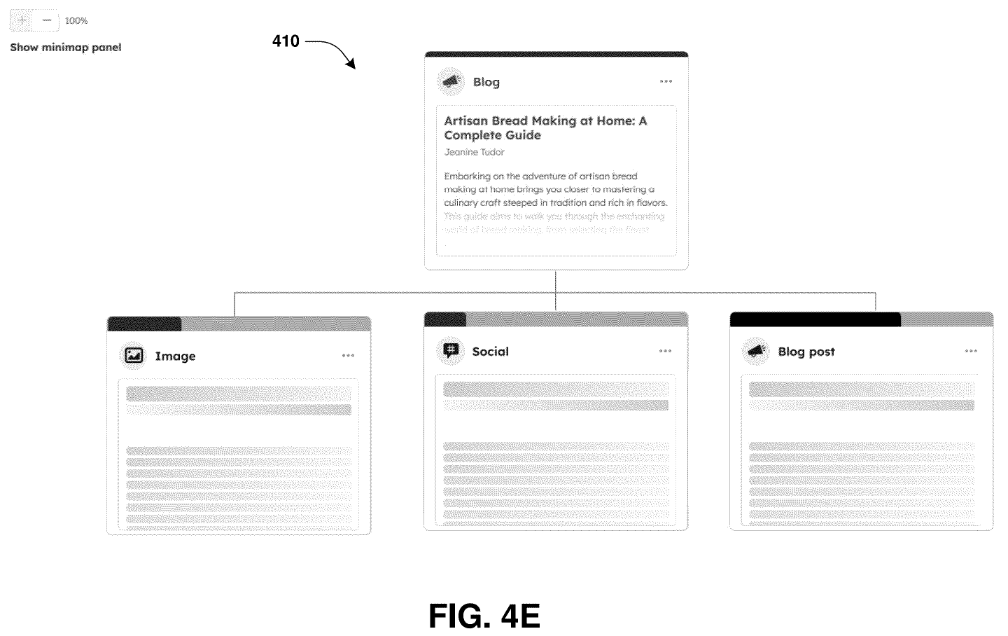

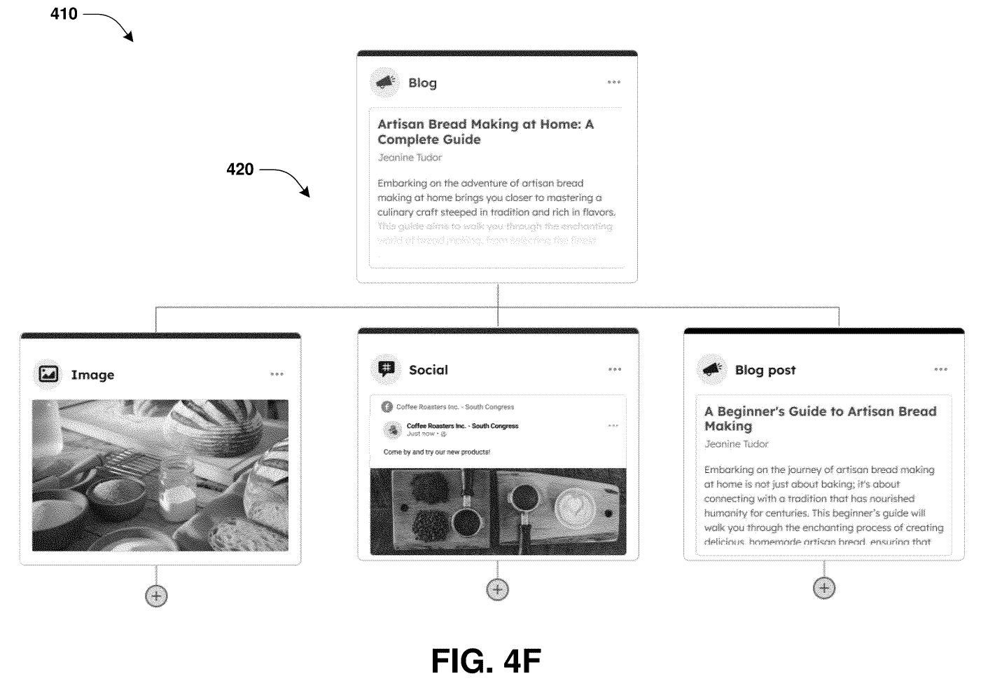

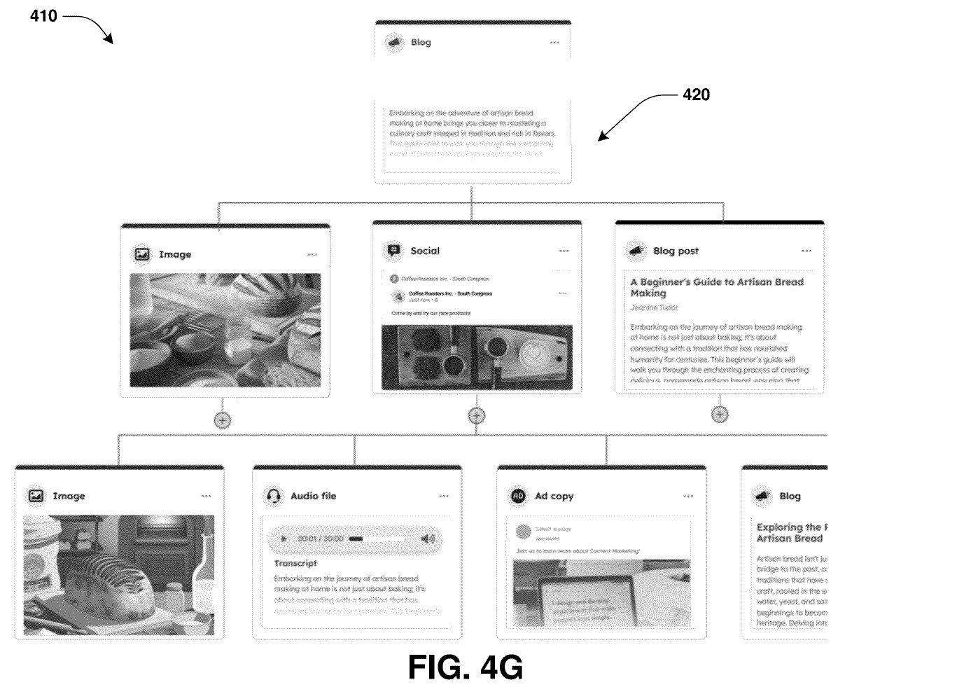

FIG. 4A is a block diagram illustrating an embodiment of a user interface 402 for multi-channel content remix. The user interface 402 is populated with an interface 404 through which a user can select or upload source content to transform into new content using the execution engine 106. The user interface 402 is populated with an interface 406 through which the user may specify or select an output content type of the new content and a content provider channel type (e.g., create and publish a social network post through a particular social network profile). The user interface 402 is populated with an interface 408 through which the user may specify user configuration properties for the new content.

FIG. 4B-4G illustrate examples of a user interface 410 for multi-channel content remix. The user interface 410 may display an interface 412 through which a user may add source content, as illustrated by FIG. 4B. The user may select a blog post 416 as the source content. The user interface 410 may provide the user with an interface 414 to select content types of new content to create such as images, social media content, blog posts, content recommendations as such ads, text messages such as SMS, landing pages, emails, audio files, etc., as illustrated by FIG. 4C. For example, the user may select a social network post as the new content to generate. The user interface 410 may provide the user with an interface 418 to add attributes, such as a style for an image (e.g., the user may select an option where artificial intelligence selects the style), image dimensions (e.g., square, a certain number or pixels, a certain length and width, etc.), social attributes (e.g., associate the new content with a particular social media profile), an objective of the social media post that will be used as input instructions for a machine learning model to generate the social media post, and an option to include a generated image in the social media post, as illustrated by FIG. 4D. A graph structure may be created for a flow to execute. The graph structure 420 may include nodes such as the blog post source content, an image to create, a social media post to create, a blog post to create, and a content recommendation to create, as illustrated by FIG. 4E. The nodes are dynamically rendered with previews of the new content as the new content is being generated, as illustrated by FIG. 4F. The graph structure may be populated with any number or levels of nodes related to content to generate, such as nodes related to a content recommendation to create, a landing page to create, an email to create, and an audio file to create, as illustrated by FIG. 4G

In some embodiments, a method is provided. The method includes defining a flow for generating new content based upon source content, an output content type, and configurations attributes, wherein the flow is defined with nodes arranged according to a graph structure, and wherein a downstream node utilizes output from an upstream node as input; executing the flow by an execution engine, wherein for each node: identifying an executor associated with a node type assigned to the node; in response to the node being the downstream node, extracting, by the executor, information from the input to generate a prompt based upon the output content type and the configuration attributes; and invoking, by the executor, a machine learning model using the prompt to generate a node result for generating the new content; in response to determining that the nodes of the flow successfully executed, generating the new content utilizing node results generated from execution of the flow by the execution engine; and providing the new content through a content provider channel for access by a computing device.

In some embodiments, the method includes executing the flow to transform the source content from a first content type to the output content type using at least one of a large language model, an artificial intelligence content generator, or machine learning models, wherein the first content type or the output content type corresponds to at least one of a blog, an audio summary, a landing page, a social network post, an email, an image, a video, a document, a presentation, a spreadsheet, an object for storing within a customer relationship management system, or text.

In some embodiments, the method includes defining each node based upon the new content to generate, wherein each node includes at least one of a proprietary prompt, logic to generate content of a particular content type, user specified attributes for generating the content.

In some embodiments, the method includes defining a top-level node to represent the source content; and configuring the top-level node with at least one of feature extraction for the source content, content sanitization for the source content, data cleanup for the source content, summarization for the source content, or key point identification for the source content.

In some embodiments, the method includes executing the flow a plurality of times to generate variations of the new content; and providing the variations of the new content to a user for selection.

In some embodiments, the method includes while executing the flow by the execution engine, duplicating the nodes into an execution history table as duplicated nodes to preserve the graph structure of the nodes, wherein a duplicated node of a node stores attributes of the node, an execution status of the node, and a result of the node being executed.

In some embodiments, the method includes coordinating, by the executor, multiple calls to application programming interfaces and large language models in parallel or in series to generate an interstitial state of the output content type that is stored into an execution history table as a node result.

In some embodiments, the method includes queuing the nodes within a queue; and assigning states to the nodes, wherein the states include at least one of a waiting state, a running state, a success state, or a failed state.

In some embodiments, the method includes processing the nodes from a top-level node down through branches to leaf nodes.

In some embodiments, a computing device is provided. The computing device comprises a memory comprising machine executable code; and a processor coupled to the memory, the processor configured to execute the machine executable code to cause the processor to perform operations comprising: defining a flow for generating new content based upon source content, an output content type, and configurations attributes, wherein the flow is defined with nodes arranged according to a graph structure, and wherein a downstream node utilizes output from an upstream node as input; executing the flow by an execution engine, wherein for each node: identifying an executor associated with a node type assigned to the node; in response to the node being the downstream node, extracting, by the executor, information from the input to generate a prompt based upon the output content type and the configuration attributes; and invoking, by the executor, a machine learning model using the prompt to generate a node result for generating the new content; in response to determining that the nodes of the flow successfully executed, generating the new content utilizing node results generated from execution of the flow by the execution engine; and providing the new content through a content provider channel for access by a computing device.

In some embodiments, the operations include determining whether a node is to be executed or cloned from a prior execution; and in response to determining that the node is not to be cloned or is unable to be cloned, executing the node.

In some embodiments, the operations include determining whether a node is to be executed or cloned from a prior execution; and in response to determining that the node is to be cloned, copying attributes and an execution result from the prior execution.

In some embodiments, the operations include in response to not identifying the executor associated with the node type, assigning a failed status to the node.

In some embodiments, the operations include in response to the executor failing to execute the node, assigning the node and downstream nodes with a failed status.

In some embodiments, the operations include in response to successfully executing a leaf node of a branch, evaluating the graph structure to determine whether nodes of other branches have completed execution; and in response to determining that all nodes have successfully executed, marking the flow as complete.

In some embodiments, a non-transitory machine readable medium is provided. The non-transitory machine readable medium comprises instructions for performing a method, which when executed by a machine, causes the machine to perform operations comprising: defining a flow for generating new content based upon source content, an output content type, and configurations attributes, wherein the flow is defined with nodes arranged according to a graph structure, and wherein a downstream node utilizes output from an upstream node as input; executing the flow by an execution engine, wherein for each node: identifying an executor associated with a node type assigned to the node; in response to the node being the downstream node, extracting, by the executor, information from the input to generate a prompt based upon the output content type and the configuration attributes; and invoking, by the executor, a machine learning model using the prompt to generate a node result for generating the new content; in response to determining that the nodes of the flow successfully executed, generating the new content utilizing node results generated from execution of the flow by the execution engine; and providing the new content through a content provider channel for access by a computing device.

In some embodiments, the operations include polling a backend system hosting the execution engine for status information for the nodes; and populating a user interface with status information for the nodes.

In some embodiments, the operations include in response to the node having a running state, displaying a colored progress bar through the user interface, wherein the colored progress bar is configured with a color corresponding to the node type of the node, and wherein the colored progress bar has a duration estimated based upon a runtime of the node computed based upon at least one of historic node execution results or a node attribute configuration of the node.

In some embodiments, the operations include displaying a colored progress bar through the user interface, wherein the colored progress bar is configured with a color corresponding to a state of the node.

In some embodiments, the operations include populating the user interface with a representation of a node through which a preview of content being generated by execution of the node is displayed.

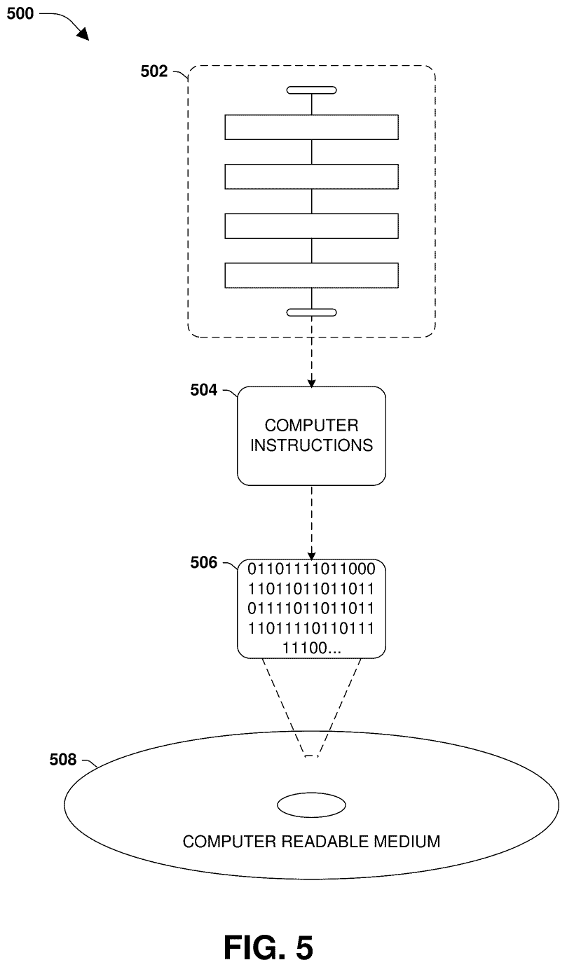

A computer-readable medium comprises processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, for example. In some embodiments, the processor-executable instructions 504 are configured to implement a system, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims. As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. A component may reside within a process and/or thread of execution and a component may be localized on one computer and/or distributed between two or more computers. Furthermore, the claimed subject matter may be implemented as a method, apparatus, or article of manufacture using programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Many modifications may be made to this configuration without departing from the scope or spirit of the claimed subject matter.

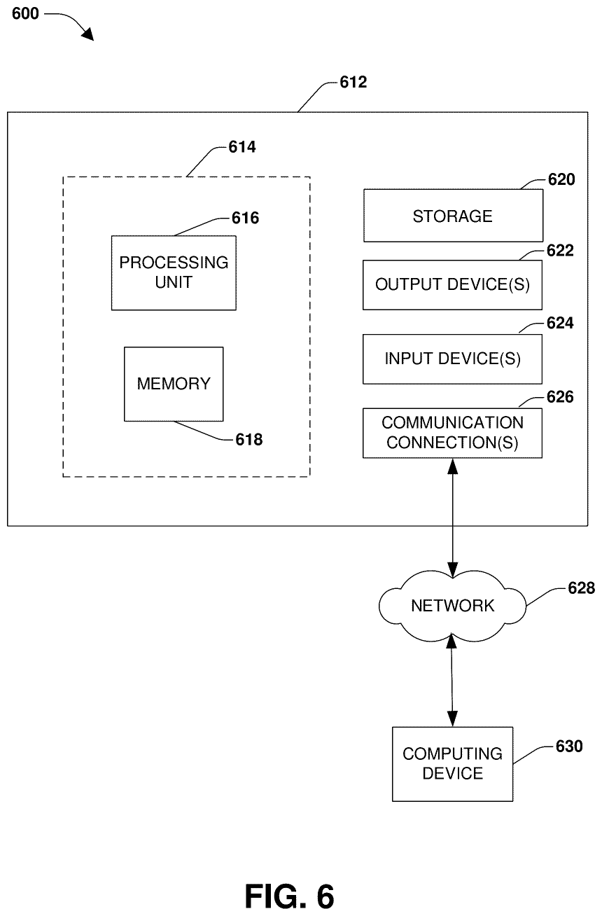

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like. Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614. In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example. The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612.

Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media. The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal. Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, etc. In one embodiment, an input device or an output device from another computing device may be used as input device(s) 624 or output device(s) 622 for computing device 612. Components of computing device 612 may be connected by various interconnects, such as a bus. Components of computing device 612 may be interconnected by a network. For example, memory 618 may be comprised of multiple physical memory units located in different physical locations interconnected by a network. For example, a computing device 630 accessible via a network 628 may store computer readable instructions to implement one or more embodiments provided herein.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments. Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object. Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
defining a flow for generating new content based upon source content, an output content type, and configurations attributes, wherein the flow is defined with nodes arranged according to a graph structure, and wherein a downstream node utilizes output from an upstream node as input;
executing the flow by an execution engine, wherein for each node:
identifying an executor associated with a node type assigned to the node;
in response to the node being the downstream node, extracting, by the executor, information from the input to generate a prompt based upon the output content type and the configuration attributes; and
invoking, by the executor, a machine learning model using the prompt to generate a node result for generating the new content;
in response to determining that the nodes of the flow successfully executed, generating the new content utilizing node results generated from execution of the flow by the execution engine; and
providing the new content through a content provider channel for access by a computing device.

2. The method of claim 1, comprising:
executing the flow to transform the source content from a first content type to the output content type using at least one of a large language model, an artificial intelligence content generator, or machine learning models, wherein the first content type or the output content type corresponds to at least one of a blog, an audio summary, a landing page, a social network post, an email, an image, a video, a document, a presentation, a spreadsheet, an object for storing within a customer relationship management system, or text.

3. The method of claim 1, comprising:
defining each node based upon the new content to generate, wherein each node includes at least one of a proprietary prompt, logic to generate content of a particular content type, user specified attributes for generating the content.

4. The method of claim 1, comprising:
defining a top-level node to represent the source content; and
configuring the top-level node with at least one of feature extraction for the source content, content sanitization for the source content, data cleanup for the source content, summarization for the source content, or key point identification for the source content.

5. The method of claim 1, comprising:
executing the flow a plurality of times to generate variations of the new content; and
providing the variations of the new content to a user for selection.

6. The method of claim 1, comprising:
while executing the flow by the execution engine, duplicating the nodes into an execution history table as duplicated nodes to preserve the graph structure of the nodes, wherein a duplicated node of a node stores attributes of the node, an execution status of the node, and a result of the node being executed.

7. The method of claim 1, comprising:
coordinating, by the executor, multiple calls to application programming interfaces and large language models in parallel or in series to generate an interstitial state of the output content type that is stored into an execution history table as a node result.

8. The method of claim 1, comprising:
queuing the nodes within a queue; and
assigning states to the nodes, wherein the states include at least one of a waiting state, a running state, a success state, or a failed state.

9. The method of claim 1, comprising:
processing the nodes from a top-level node down through branches to leaf nodes.

10. A computing device comprising:
a memory comprising machine executable code; and
a processor coupled to the memory, the processor configured to execute the machine executable code to cause the processor to perform operations comprising:
defining a flow for generating new content based upon source content, an output content type, and configurations attributes, wherein the flow is defined with nodes arranged according to a graph structure, and wherein a downstream node utilizes output from an upstream node as input;
executing the flow by an execution engine, wherein for each node:
identifying an executor associated with a node type assigned to the node;
in response to the node being the downstream node, extracting, by the executor, information from the input to generate a prompt based upon the output content type and the configuration attributes; and
invoking, by the executor, a machine learning model using the prompt to generate a node result for generating the new content;
in response to determining that the nodes of the flow successfully executed, generating the new content utilizing node results generated from execution of the flow by the execution engine; and
providing the new content through a content provider channel for access by a computing device.

11. The computing device of claim 10, wherein the operations comprise:
determining whether a node is to be executed or cloned from a prior execution; and
in response to determining that the node is not to be cloned or is unable to be cloned, executing the node.

12. The computing device of claim 10, wherein the operations comprise:
determining whether a node is to be executed or cloned from a prior execution; and
in response to determining that the node is to be cloned, copying attributes and an execution result from the prior execution.

13. The computing device of claim 10, wherein the operations comprise:
in response to not identifying the executor associated with the node type, assigning a failed status to the node.

14. The computing device of claim 10, wherein the operations comprise:
in response to the executor failing to execute the node, assigning the node and downstream nodes with a failed status.

15. The computing device of claim 10, wherein the operations comprise:
in response to successfully executing a leaf node of a branch, evaluating the graph structure to determine whether nodes of other branches have completed execution; and
in response to determining that all nodes have successfully executed, marking the flow as complete.

16. A non-transitory machine readable medium comprising instructions for performing a method, which when executed by a machine, causes the machine to perform operations comprising:
defining a flow for generating new content based upon source content, an output content type, and configurations attributes, wherein the flow is defined with nodes arranged according to a graph structure, and wherein a downstream node utilizes output from an upstream node as input;
executing the flow by an execution engine, wherein for each node:
identifying an executor associated with a node type assigned to the node;
in response to the node being the downstream node, extracting, by the executor, information from the input to generate a prompt based upon the output content type and the configuration attributes; and
invoking, by the executor, a machine learning model using the prompt to generate a node result for generating the new content;
in response to determining that the nodes of the flow successfully executed, generating the new content utilizing node results generated from execution of the flow by the execution engine; and
providing the new content through a content provider channel for access by a computing device.

17. The non-transitory machine readable medium of claim 16, wherein the operations comprise:
polling a backend system hosting the execution engine for status information for the nodes; and
populating a user interface with status information for the nodes.

18. The non-transitory machine readable medium of claim 17, wherein the operations comprise:
in response to the node having a running state, displaying a colored progress bar through the user interface, wherein the colored progress bar is configured with a color corresponding to the node type of the node, and wherein the colored progress bar has a duration estimated based upon a runtime of the node computed based upon at least one of historic node execution results or a node attribute configuration of the node.

19. The non-transitory machine readable medium of claim 17, wherein the operations
displaying a colored progress bar through the user interface, wherein the colored progress bar is configured with a color corresponding to a state of the node.

20. The non-transitory machine readable medium of claim 17, wherein the operations
populating the user interface with a representation of a node through which a preview of content being generated by execution of the node is displayed.
